(19) United States
(12) Patent Application Publication
(10) Pub. No.: US 2010/0060408 A1
(43) Pub. Date: Mar. 11, 2010

(54) FUSE MODULE WITH INDICATING CAPABILITY

(76) Inventors: Wen-Tsung Cheng, Taoyuan (TW); Wen-Ho Cheng, Taoyuan (TW)

Correspondence Address: HDLS Patent & Trademark Services, P.O. BOX 220746, CHANTILLY, VA, 20153-0746, US

(21) Appl. No.: 12/206,877

(22) Filed: Sep. 9, 2008

(51) Int. Cl. H01H 85/30

(52) U.S. Cl. 337/241; 337/227; 337/260

(57) ABSTRACT

A fuse module with an indicating capability allows a plug having pins to be inserted therein. The fuse module includes a casing, an electrical conductive terminal, an insulator and a light-emitting unit. The bottom of the casing is provided with through holes. The electrical conductive terminal is received in the casing. The electrical conductive terminal includes conductive pieces for allowing the pins to be inserted therein and a connecting arm for connecting the conductive pieces. The conductive pieces are arranged to correspond to the through holes. The insulator is fixed to the connecting arm. The light-emitting unit is provided between the insulator and the casing and is electrically connected with the conductive pieces. When the current is overloaded, the connecting arm will be melted to break, so that the light-emitting unit will be lighted up to generate an indicating effect. Since the electrical conductive terminal and the light-emitting unit are replaceable, the cost can be reduced and the requirement for the environmental protection can be satisfied.

### BACKGROUND OF THE INVENTION

1. Field of the Invention

The present invention relates to a fuse module, and in particular to a fuse module with an indicating capability.

2. Description of Prior Art

The fuse is an over-current protection device that is widely used in electronic products or circuits. When the flowing current exceeds the maximum limit of the fuse, the fuse will be blown, thereby preventing the excessive current from damaging the electronic elements within the electronic product. A conventional fuse module corresponding to a plug having pins includes a casing, an electrical conductive piece and a light-emitting unit. The bottom of the casing is provided with a through hole. The electrical conductive piece is received in the casing to correspond to the though hole. The light-emitting unit is also received in the casing and fixed to the electrical conductive piece in parallel.

Since the light-emitting unit can be connected in series to a resistor. Alternatively, the resistance of the light-emitting unit is larger than that of the electrical conductive piece. In a normal situation, the current will pass through the electrical conductive piece. When the current flowing through the electrical conductive piece is too large, the electrical conductive piece will be melted to break, so that the current will flow through the light-emitting unit to light it up.

However, in practice, the above-mentioned fuse module still has some drawbacks as follows. Since the light-emitting unit is inserted and accommodated in the casing and also may be soldered with the electrical conductive piece, when the electrical conductive piece is blown and cannot be used any more, the light-emitting unit should be thrown away together with the damaged fuse module, which causes the waste of money. Especially, in order to conform to the requirement for environmental protection, it is necessary to improve such a fuse module.

Therefore, it is an important issue for the present Inventor to overcome the above problems.

### SUMMARY OF THE INVENTION

The present invention is to provide a fuse module with an indicating capability. With the light-emitting unit abutting the electrical conductive terminal instead of being soldered with each other, when the electrical conductive terminal is to be replaced, the original light-emitting unit can be still used without being replaced together with the electrical conductive terminal. In this way, the cost can be saved and the requirement for environmental protection can be satisfied.

The present invention is to provide a fuse module with an indicating capability, which allows a plug having pins to be inserted therein. The fuse module includes a casing, an electrical conductive terminal, an insulator and a light-emitting unit. The bottom of the casing is provided with a plurality of through holes. The electrical conductive terminal is received in the casing. The electrical conductive terminal comprises a plurality of conductive pieces for allowing the pins to be inserted therein and a connecting arm for connecting the conductive pieces. The conductive pieces are arranged to correspond to the through holes. The insulator is fixed to the connecting arm. The light-emitting unit is provided between the insulator and the casing and is electrically connected with the conductive pieces. When the current is overloaded, the connecting arm will be melted to break, so that the light-emitting unit will be lighted up to generate an indicating effect.

The present invention is to provide a fuse module with an indicating capability. Since the electrical conductive terminal can be detached from the casing, the user only needs to replace the damaged electrical conductive terminal directly when the electrical conductive terminal is melted to break. It is unnecessary for the user to replace the whole fuse module. In this way, the cost can be saved and the requirement for environmental protection can be satisfied.

The present invention is to provide a fuse module with an indicating capability. With the illumination of the light-emitting unit, the user can recognize directly whether the electrical conductive terminal of the fuse module has to be replaced or not. Thus, it is unnecessary for the user to carefully check every fuse module with an indicating capability, thereby increasing the convenience in use.

### BRIEF DESCRIPTION OF THE DRAWINGS

FIG. 1 is an exploded perspective view of the present invention;

FIG. 2 is an exploded perspective view showing the electrical conductive terminal, insulator and light-emitting unit of the present invention;

FIG. 3 is a cross-sectional view along the line 3-3 in FIG. 1;

FIG. 4 is a cross-sectional view along the line 4-4 in FIG. 3;

FIG. 5 is a schematic view showing the operating state of the present invention;

FIG. 6 is a perspective view showing the external appearance of a second embodiment of the present invention;

FIG. 7 is a cross-sectional view along the line 7-7 in FIG. 6;

FIG. 8 is a perspective view showing the external appearance of a third embodiment of the present invention;

FIG. 9 is a cross-sectional view along the line 9-9 in FIG. 8;

FIG. 10 is a perspective view showing the external appearance of a fourth embodiment of the present invention;

FIG. 11 is a cross-sectional view along the line 11-11 in FIG. 10;

FIG. 12 is a perspective view showing the external appearance of a fifth embodiment of the present invention;

FIG. 13 is a cross-sectional view along the line 13-13 in FIG. 12;

FIG. 14 is a perspective view showing the external appearance of a sixth embodiment of the present invention;

FIG. 15 is a cross-sectional view along the line 15-15 in FIG. 14;

FIG. 16 is a perspective view showing the external appearance of a seventh embodiment of the present invention; and

FIG. 17 is a cross-sectional view along the line 17-17 in FIG. 16.

### DETAILED DESCRIPTION OF THE INVENTION

The detailed description and technical contents of the present invention will be explained with reference to the accompanying drawings. However, the drawings are illustrative only but not used to limit the present invention.

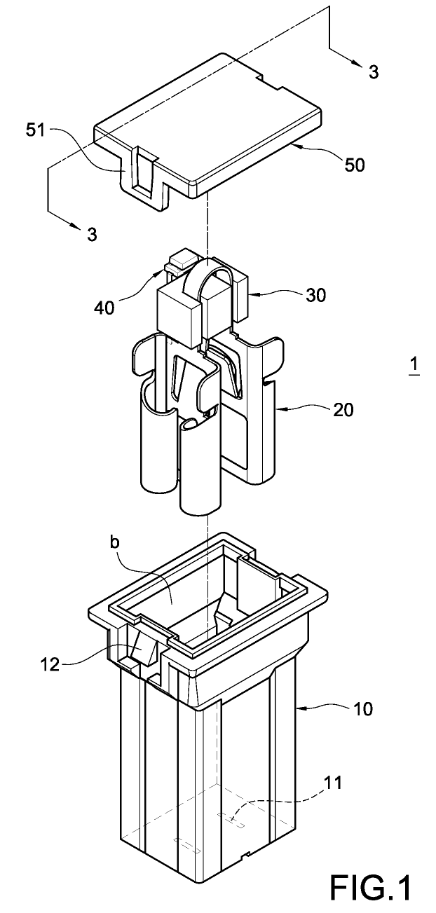

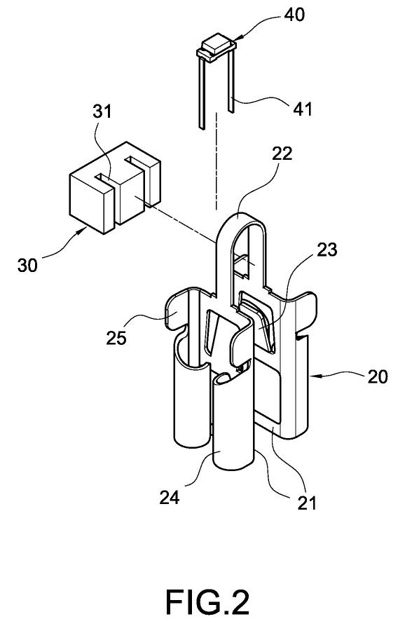

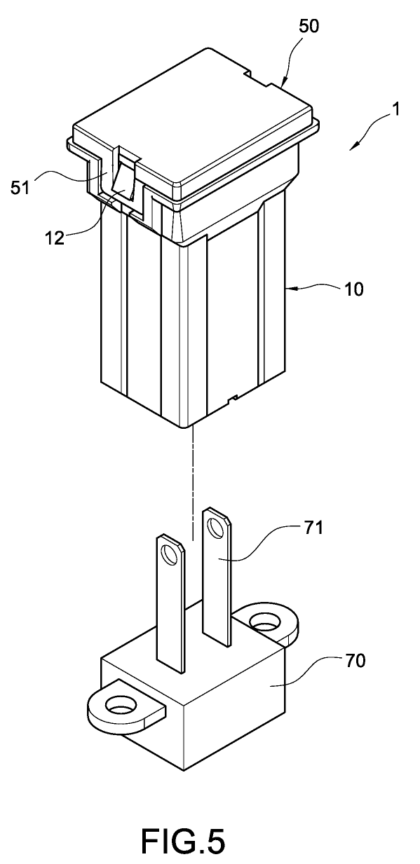

Please refer to FIGS. 1 and 2. FIG. 1 is an exploded perspective view of the present invention, and FIG. 2 is an exploded perspective view showing the electrical conductive terminal, insulator and light-emitting unit. The present invention provides a fuse module with an indicating capability that allows a plug 70 having pins 71 (FIG. 5) to be inserted therein. The fuse module 1 includes a casing 10, an electrical conductive terminal 20, an insulator 30 and a light-emitting unit 40.

The interior of the casing 10 is formed with an accommodating chamber 10, and the bottom of the casing 10 is provided with a plurality of through holes 11. Both sides of the casing 10 are formed with a block 12 respectively.

The electrical conductive terminal 20 is received in the accommodating chamber b of the casing 10. The electrical conductive terminal 20 is integrally formed into an inverted-U shape. The electrical conductive terminal 20 comprises two conductive pieces 21 and a connecting arm 22 for connecting the two conductive pieces 21. The connecting arm 22 is formed into an inverted-U shape, so that the two conductive pieces 21 can correspond to each other. Both sides of the conductive piece 21 extend to form a bent portion 24 respectively. The bent portion 24 is bent inwards. The bent portion 24 and the conductive pieces 21 can sandwich the pins 71 of the plug 70 (FIG. 5). The conductive piece 21 also extends to form an abutting end 25. The abutting end 25 abuts the inner wall of the casing 10.

Furthermore, two conductive pieces 21 are formed inwards with a positioning elastic piece 23 respectively to correspond to each other. When the electrical conductive terminal 20 is disposed in the accommodating chamber b of the casing 10, the positioning elastic piece 23 will abut the casing 10, so that the electrical conductive terminal 20 will not fall from the casing 10. Further, the electrical conductive pieces 21 and the bent portions 24 of the electrical conductive terminal 20 are arranged to correspond to the through holes 11, thereby allowing the pins 71 to be inserted therein.

The insulator 30 is fixed to the electrical conductive terminal 20. In the present embodiment, the insulator 30 is formed into a rectangular shape. One end surface of the insulator 30 is formed with a plurality of troughs 31 corresponding to the connecting arm 22. The trough 31 allows the connecting arm 22 to be disposed and fixed therein. Further, the insulator 30 is made of ceramic materials.

The light-emitting unit 40 is provided between the insulator 30 and the casing 10 and is electrically connected to the electrical conductive terminal 20. More specifically, in the present embodiment, the light-emitting unit 40 is a light-emitting diode, but it is not limited thereto. Both ends of the light-emitting unit 40 extend downwards to form a pin 41 respectively. The light-emitting unit 40 abuts the other end surface of the insulator 30. The pin 41 abuts the electrical conductive piece 21. The light-emitting unit 40 is provided with resistors. When the fuse module 1 is electrically connected, the resistance of the light-emitting unit 40 is larger than that of the electrical conductive terminal 20. When the fuse module 1 is overloaded, the connecting arm 22 of the electrical conductive terminal 20 will be melted to break, which makes the current to flow through the light-emitting unit 40 so as to generate an indicating light.

Furthermore, the fuse module 1 has an upper cover 50 corresponding to the casing 10. Both sides of the upper cover 50 extend to form a locking ring 51 to correspond to the block 12 respectively. The locking ring 51 is locked with the block 12, so that the upper cover 50 can be fixed to the casing 10. The upper cover 51 is made of a transparent material, so that the light emitted by the light-emitting unit 40 can pass through the upper cover 50 to be seen by a user.

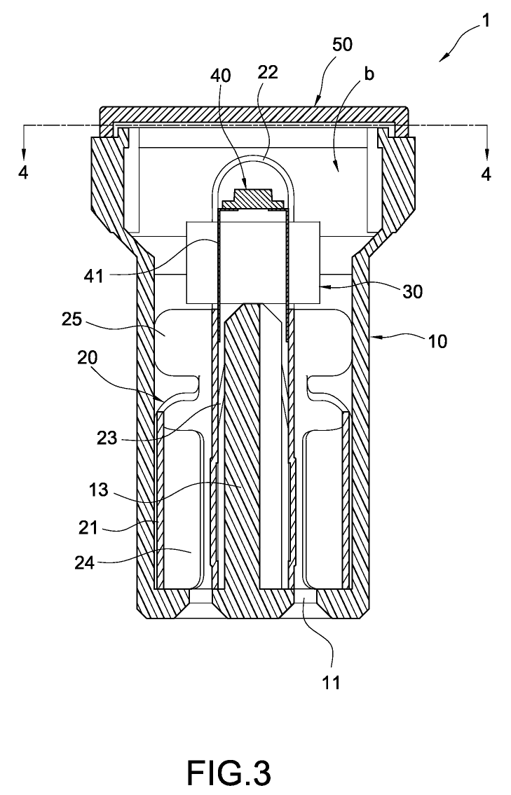

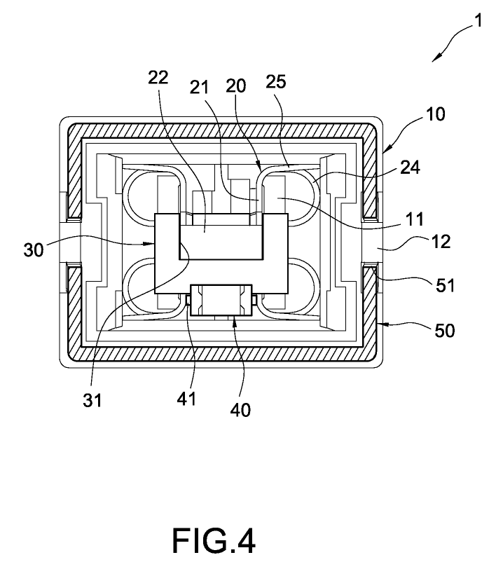

Please refer to FIGS. 3 and 4. FIG. 3 is a cross-sectional view along the line 3-3 in FIG. 1, and FIG. 4 is a cross-sectional view along the line 4-4 in FIG. 3. The bottom of the casing 10 extends upwards to form a partitioning wall 13 for separating the accommodating chamber b. When the electrical conductive terminal 20 is disposed in the accommodating chamber b, the two conductive pieces 21 are separated by the partitioning wall 13. The positioning elastic piece 23 abuts the partitioning wall 13, thereby fixing the electrical conductive terminal 20. Please refer to FIG. 4 again. The insulator 30 separates the electrical conductive terminal 20 from the light-emitting unit 40, thereby preventing the light-emitting unit 40 from electrically connecting to the electrical conductive terminal 20 directly and thus preventing the electrical conductive terminal 20 from generating a high temperature to damage the light-emitting unit 40 during its usage.

Please refer to FIG. 5, which is a schematic view showing the operating state of the present invention. The fuse module with an indicating capability of the present invention is suitable for a plug 70 having pins 71. In use, the pins 71 of the plug 70 are inserted in the through holes 11 of the fuse module 1, so that the conductive piece 21 is electrically connected with the pins 71.

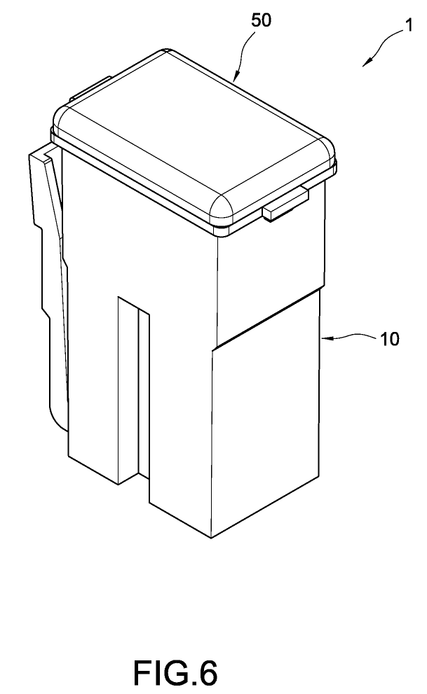

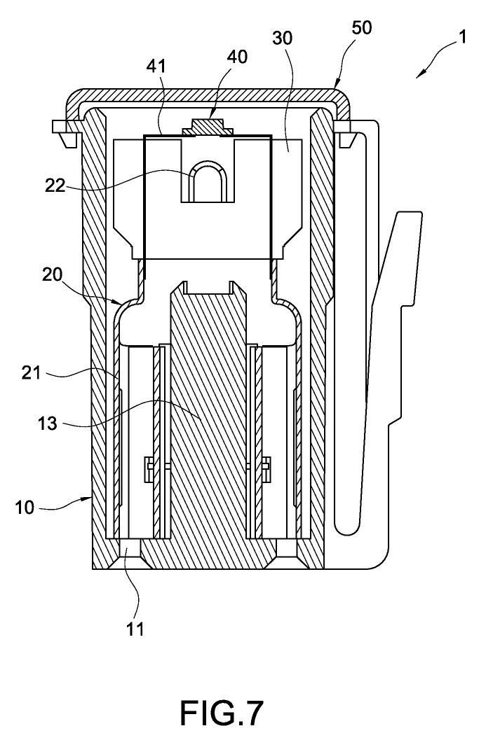

Please refer to FIGS. 6 and 7. FIG. 6 is a perspective view showing the external appearance of a second embodiment of the present invention, and FIG. 7 is a cross-sectional view along the line 7-7 in FIG. 6. In the present embodiment, the distance between two pins 41 of the light-emitting unit 40 is larger, and the structure of the insulator 30 also corresponds to the pins 41.

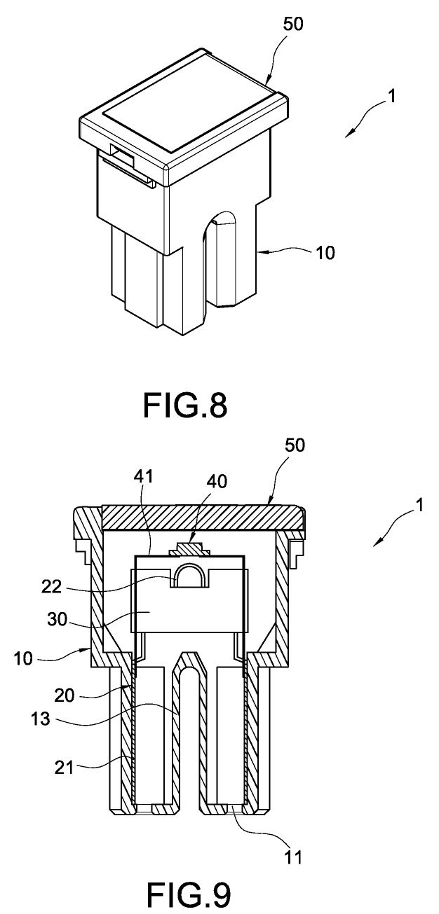

Please refer to FIGS. 8 and 9. FIG. 8 is a perspective view showing the external appearance of a third embodiment of the present invention, and FIG. 9 is a cross-sectional view along the line 9-9 in FIG. 8. In the present embodiment, the pin 41 is located farther away the connecting arm 22. Therefore, when the fuse module 1 is in use, the connecting arm 22 will generate a higher temperature. With the pins 41 being located farther away the connecting arm 22, the light-emitting unit 40 can be protected from the high temperature without suffering damage.

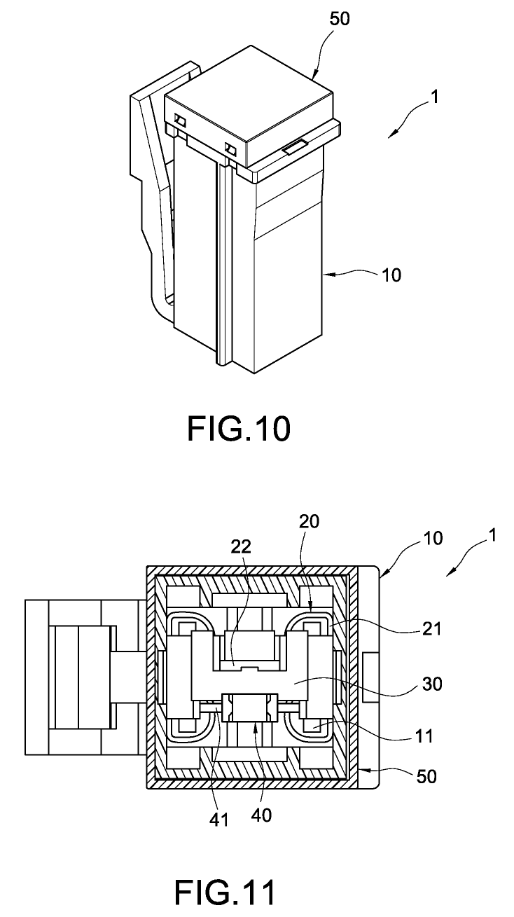

Please refer to FIGS. 10 and 11. FIG. 10 is a perspective view showing the external appearance of a fourth embodiment of the present invention, and FIG. 11 is a cross-sectional view along the line 11-11 in FIG. 10. In the present embodiment, the outer surface of the conductive piece 21 abuts the inner wall of the casing 10 completely, so that the electrical conductive terminal 20 can be connected to the casing 10 more firmly.

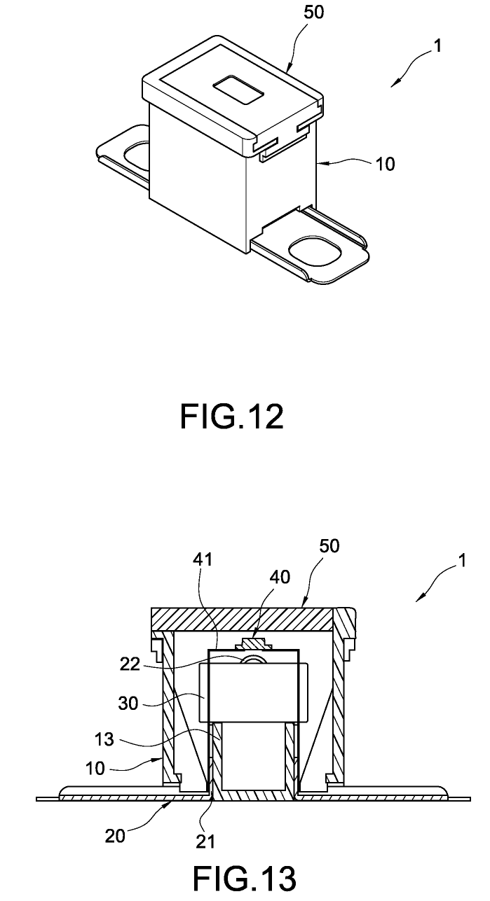

Please refer to FIGS. 12 and 13. FIG. 12 is a perspective view showing the external appearance of a fifth embodiment of the present invention, and FIG. 13 is a cross-sectional view along the line 13-13 in FIG. 12. In the present embodiment, the conductive piece 21 of the electrical conductive terminal 20 extends outwards from both sides to correspond to the plugs of different specifications (not shown).

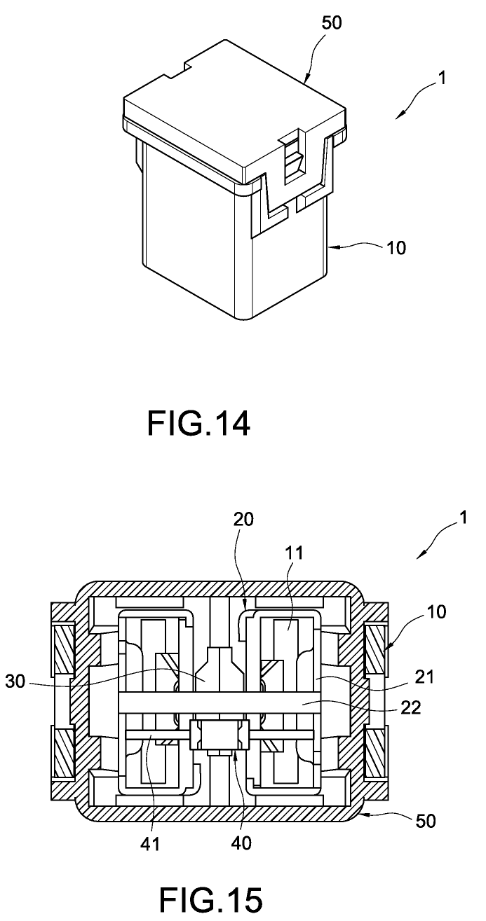

Please refer to FIGS. 14 and 15. FIG. 14 is a perspective view showing the external appearance of a sixth embodiment of the present invention, and FIG. 15 is a cross-sectional view along the line 15-15 in FIG. 14. In the present embodiment, the connecting arm 22 is connected to the outer surface of the two conductive pieces 21. The through hole 11 is formed into a rectangular shape to correspond to the plugs of different specifications (not shown).

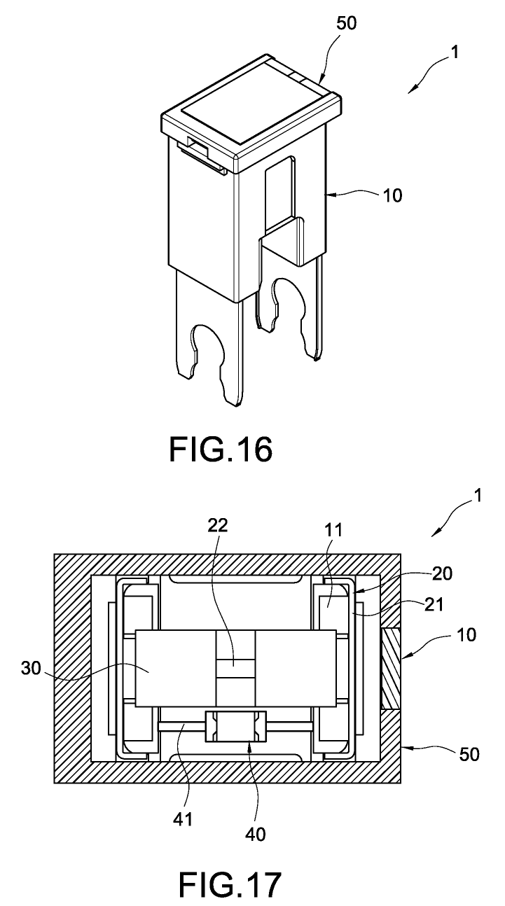

Please refer to FIGS. 16 and 17. FIG. 16 is a perspective view showing the external appearance of a seventh embodiment of the present invention, and FIG. 17 is a cross-sectional view along the line 17-17 in FIG. 16. In the present embodiment, the conductive piece 21 of the electrical conductive terminal 20 passes through the through hole 11 to be exposed to the underside of the casing 10.

Therefore, the fuse module with an indicating capability of the present invention has advantageous features as follows.

(I) Since the electrical conductive terminal 20 can be detached from the casing 10, the user only needs to replace the damaged electrical conductive terminal 20 when the electrical conductive terminal 20 is melted to break. It is unnecessary for the user to replace the whole fuse module 1. Therefore, the cost can be saved and the requirement for environmental protection can be achieved.

(II) Since the light-emitting unit 40 abuts the electrical conductive terminal 20 instead of being soldered with each other, when the user intends to replace the electrical conductive terminal 20, the user can keep the original light-emitting unit 40 without being replaced together with the electrical conductive terminal 20. Therefore, the cost can be saved and the requirement for environmental protection can be achieved.

(III) With the illumination of the light-emitting unit 40, the user can recognize directly whether the electrical conductive terminal 20 of the fuse module 1 has to be replaced or not. Thus, it is unnecessary for the user to carefully check every fuse module 1, thereby increasing the convenience in use.

According to the above, the fuse module with an indicating module of the present invention already has industrial applicability, novelty and inventive steps. Further, the structure of the present invention has not been seen in articles of the same kind or let in public use. Therefore, the present invention conforms to the requirements for a utility model patent.

What is claimed is:

1. A fuse module with an indicating capability for allowing a plug having plug pins to be inserted therein, the fuse module comprising:
a casing with a bottom thereof having a plurality of through holes;
an electrical conductive terminal received in the casing, the electrical conductive terminal comprising a plurality of conductive pieces for allowing the plug pins to be inserted therein and a connecting arm for connecting the conductive pieces, the conductive pieces being arranged to correspond to the through holes;
an insulator fixed to the connecting arm; and
a light-emitting unit provided between the insulator and the casing and electrically connected with the conductive pieces;
wherein when the current is overloaded, the connecting arm is melted to break, so that the light-emitting unit is lighted up to generate an indicating effect.

2. The fuse module with an indicating capability according to claim 1, wherein an interior of the casing is formed with an accommodating chamber, and the electrical conductive terminal is received in the accommodating chamber.

3. The fuse module with an indicating capability according to claim 1, wherein the insulator is formed with a plurality of troughs corresponding to the connecting arm, and the troughs allow the connecting arm to be fixed therein.

4. The fuse module with an indicating capability according to claim 3, wherein the insulator is made of ceramic materials.

5. The fuse module with an indicating capability according to claim 1, wherein both sides of the conductive pieces extend to form a bent portion respectively, and the bent portion and the conductive piece sandwich the plug pins.

6. The fuse module with an indicating capability according to claim 1, wherein the conductive piece extends to form an abutting end, and the abutting end abuts an inner wall of the casing and is fixed thereto.

7. The fuse module with an indicating capability according to claim 1, wherein the conductive piece is formed with a positioning elastic piece, a bottom of the casing extends upwards to form a partitioning wall, the positioning elastic piece abuts the partitioning wall to be fixed thereto.

8. The fuse module with an indicating capability according to claim 1, wherein both ends of the light-emitting unit extend to form a pin respectively, and the pins abut the conductive pieces.

9. The fuse module with an indicating capability according to claim 8, wherein the light-emitting unit is a light-emitting diode.

10. The fuse module with an indicating capability according to claim 1, further comprising an upper cover, both sides of the upper cover extending to form a locking ring respectively, both sides of the casing being formed with a block respectively, the locking ring being locked with the block.

11. The fuse module with an indicating capability according to claim 10, wherein the upper cove is made of a transparent material.
